(19) United States
(12) Patent Application Publication
(10) Pub. No.: US 2014/0118342 A1
(43) Pub. Date: May 1, 2014

(54) INFORMATION PROCESSING APPARATUS AND DRAWING METHOD

(71) Applicant: FUJITSU LIMITED, Kawasaki-shi (JP)

(72) Inventors: Yukihiko FURUMOTO, Kawasaki (JP); Masayuki KIDERA, Kawasaki (JP)

(73) Assignee: FUJITSU LIMITED, Kawasaki-shi (JP)

(21) Appl. No.: 14/048,093

(22) Filed: Oct. 8, 2013

(30) Foreign Application Priority Data
Oct. 25, 2012 (JP) 2012-235316

(51) Int. Cl. G06T 19/00

(52) U.S. Cl. CPC G06T 19/003
USPC 345/419

(57) ABSTRACT

A memory stores information on a plurality of operations that change information on the object location. Upon sequentially performing a first operation through a second operation of the plurality of operations, a computation unit generates information on the object outline after the second operation, without generating information on the object outline for each of the first operation through an operation immediately before the second operation. The computation unit draws an object using the generated information on the object outline after the second operation.

### CROSS-REFERENCE TO RELATED APPLICATION

This application is based upon and claims the benefit of priority of the prior Japanese Patent Application No. 2012-235316, filed on Oct. 25, 2012, the entire contents of which are incorporated herein by reference.

### FIELD

The embodiments discussed herein are related to an information processing apparatus and a drawing method.

### BACKGROUND

Currently, there are information processing apparatuses that are used for supporting design and development. Computer aided design (CAD), digital mock-up (DMU), and the like are technologies available for supporting design, for example. CAD is a technology that supports the design process of two-dimensional (2D) or three-dimensional (3D) models. DMU is a technology that generates a product model by assembling a plurality of component models such that the assembly and disassembly processes and the behavior and operability of the product are verified before creating a prototype. With DMU, it is possible to represent the flexibility (for example, deflection) of cables and wiring harnesses, and thus to perform verification close to verification of the actual product.

Further, there have been disclosed various methods for graphically representing the motion of an object. For example, one proposed method is to change a conversion matrix for specifying the position of a higher-level component of an object with respect to a lower-level component of the object over the course of time, and thus to sequentially display images illustrating how the attitude of the object changes on the screen on the basis of the conversion matrix. Another proposed method is to represent the shape of a 3D model using a function, and thus to display changes in the shape of the 3D model in animation using the function.

Still another proposed method is to preferentially select a display object that takes longer time to be drawn, and draw other display objects on the screen before drawing the selected display object.

Note that these methods are disclosed in, for example, Japanese Laid-open Patent Publications. No. 61-243567, No. 5-242219, No. 9-6990, and No. 2008-185885, and Fujitsu Limited, “VPS/Harness (harness verification)”, [online], (searched on Jun. 18, 2012, Internet (URL: jp.fujitsu.com/solutions/plm/virtual/vps/harness.html).

Upon drawing an object, information on the outline of the object is often generated on the basis of information on the location of the object. Thus, the object is drawn using the generated outline information. For instance, unlike a rigid body, an object having flexibility (hereinafter referred to as a “flexible body”) is instable, and its outline may change depending on its location. For example, if the position of an end of a cable changes, the degree of deflection of the entire cable also changes. In some cases, in order to graphically represent such a change, each time the location of the flexible body changes, information on the outline of the flexible body is generated on the basis of the information on the location of the flexible body by performing a predetermined computation. Then, the flexible body is drawn using the generated information.

In these cases, however, when reproducing a series of operations on the object, the drawing operation might be delayed. For example, if computation for generating information on the outline of the flexible body is performed each time one of a series of operations is performed, it might take time until the state of the object after the plurality of operations is checked.

### SUMMARY

According to one aspect of the invention, there is provided an information processing apparatus that is used for a process of generating, on the basis of first information indicating a location of an object, second information indicating an outline of the object, and drawing the object using the second information. This information processing apparatus includes a memory configured to store information on a plurality of operations that change the first information; and a processor configured to perform a procedure including generating, upon sequentially performing a first operation through a second operation of the plurality of operations, second information after the second operation without generating second information for each of the first operation through an operation immediately before the second operation, and drawing the object using the generated second information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing apparatus according to a first embodiment;

FIG. 2 illustrates an exemplary hardware configuration of a design support apparatus according to a second embodiment;

FIG. 3 illustrates an exemplary software configuration of the design support apparatus according to the second embodiment;

FIG. 4 illustrates an example of drawing of an assembly according to the second embodiment;

FIG. 5 illustrates an example of 3D data according to the second embodiment;

FIG. 6 illustrates an example of a triangle table according to the second embodiment;

FIG. 7 illustrates an example of a passing point table according to the second embodiment;

FIG. 8 illustrates an example of an operation history table according to the second embodiment;

FIG. 9 illustrates an example of a change management table according to the second embodiment;

FIG. 10 is a flowchart illustrating an example of a process according to the second embodiment;

FIG. 11 is a flowchart illustrating an example of change management according to the second embodiment;

FIG. 12 illustrates an example of change management according to the second embodiment;

FIG. 13 is a flowchart illustrating an example of drawing processing according to the second embodiment;

FIGS. 14A and 14B illustrate a comparison between the process of the second embodiment and another process;

FIG. 15 illustrates an example of a change management table according to a third embodiment;

FIG. 16 is a flowchart illustrating an example of change management according to the third embodiment;

FIG. 17 illustrates an example of change management according to the third embodiment;

FIG. 18 illustrates an exemplary software configuration of a design support apparatus according to a fourth embodiment;

FIG. 19 illustrates examples of blocks according to the fourth embodiment;

FIG. 20 is an example of a block management table according to the fourth embodiment;

FIG. 21 is a flowchart illustrating an example of performing drawing according to the fourth embodiment;

FIGS. 22A and 22B illustrate examples of methods of specifying an attention point according to the fourth embodiment; and

FIG. 23 illustrates a comparison between the process of the fourth embodiment and another process.

### DESCRIPTION OF EMBODIMENTS

Several embodiments will be described below with reference to the accompanying drawings, wherein like reference numerals refer to like elements throughout.

### (a) First Embodiment

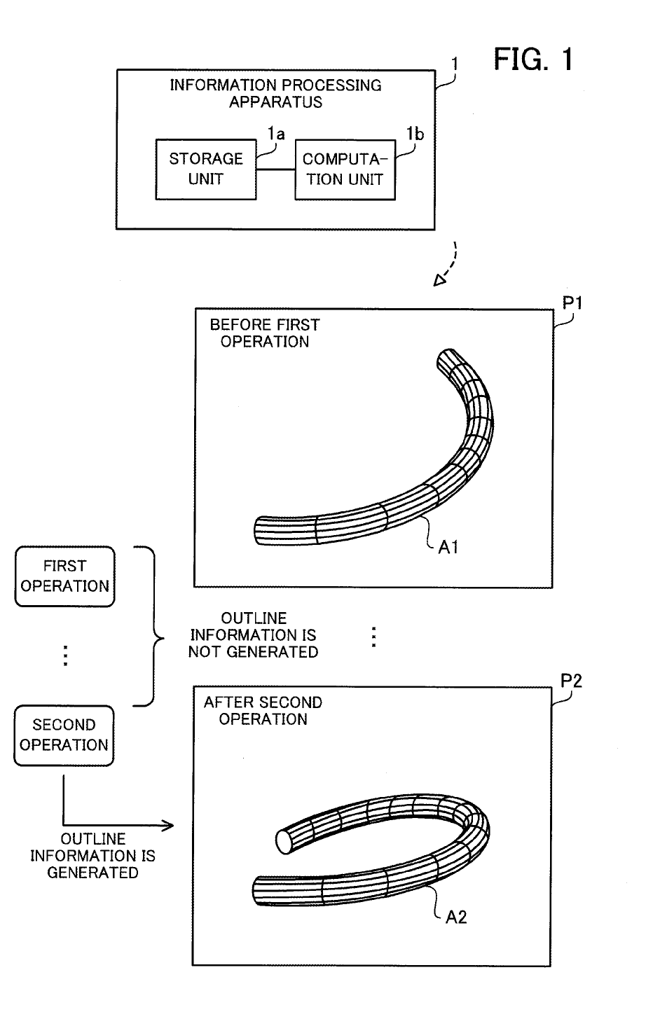

FIG. 1 illustrates an information processing apparatus 1 according to a first embodiment. The information processing apparatus 1 provides a DMU function, for example. The information processing apparatus 1 generates information (second information) on the outline of an object on the basis of information (first information) on the location of the object, and draws the object using the information on the object outline. The information processing apparatus 1 includes a storage unit 1a and a computation unit 1b. The storage unit 1a may be a memory such as a random access memory (RAM) or the like. The computation unit 1b may be a processor such as a central processing unit (CPU), a graphics processing unit (GPU), or the like. Information processing in the first embodiment may be realized when the computation unit 1b executes a program stored in the storage unit 1a.

The storage unit 1a stores information on a plurality of operations that change the information on the object location. The information on the object location may be, for example, information on a plurality of coordinate points serving as references for the location of the object. For example, in the case of representing a linear object such as a cable or the like, the information on the object location may be information on a plurality of passing points through which the cable extends. In the case of representing a planar object such as a rubber film or the like, the information on the object location may be information on points on a certain plane in the object. In the case of representing an object such as a gel body, the information on the object location may be information on grid points of the object. The information on the object location may include information on the attitude of the object in that location.

An operation that changes the information on the object location may be, for example, an operation that changes the information on a plurality of coordinate points serving as references for the location of the object or the information on the attitude of the object described above. This operation may make a direct change or may make an indirect change. Making a direct change is, for example, to change the location of the object directly. In the case of a cable, making a direct change is to change the location of the cable itself in a 3D space. Making an indirect change is, for example, to change the location of another object to which the object is connected, and thereby change the location of the object in accordance with the change in the location of the other object. In the case of a cable connected to another component, making an indirect change is to change the location of the other component in a 3D space, and thereby change the location of the cable in the 3D space in accordance with the change in the location of the other component.

Upon sequentially performing a first operation through a second operation of a plurality of operations, the computation unit 1b generates information on the object outline after the second operation, without generating information on the object outline for each of the first operation through an operation immediately before the second operation. Note that the next operation immediately after the first operation may be the second operation. In this case, the operation immediately before the second operation is the first operation.

The following describes a case where images P1 and P2 of a cable are generated, for example. In this case, the term “operation” indicates an operation that changes information on the location of the cable. In the image P1, an outline A1 of the cable is drawn. The image P1 is an image before a first operation (immediately before a first operation). In the image P2, an outline A2 of the cable is drawn. The image P2 is an image after a second operation.

For example, the computation unit 1b receives an instruction for sequentially performing the first through second operations. This instruction may be input to the computation unit 1b by the user using an input device connected to the information processing apparatus 1. The computation unit 1b sequentially performs the first through second operations with reference to the storage unit 1a. The computation unit 1b generates information on the outline A2 of the cable after the second operation, without generating information on the outline of the cable for each of the first operation through an operation immediately before the second operation.

The computation unit 1b may change information on the object location for each of the first operation through the operation immediately before the second information. In this case, the computation unit 1b generates information on the object location after the second operation, on the basis of information on the object location after the operation immediately before the second operation.

Alternatively, the computation unit 1b may generate information on the amount of change in the information on the object location for each of the first operation through the operation immediately before the second information. In this case, the computation unit 1b generates information on the object location after the second operation, on the basis of the information on the amount of change. In this case, the information on the object location for each of the first operation through the operation immediately before the second information may not be changed each time an operation is performed.

The computation unit 1b draws the object using the generated information on the object outline after the second operation. For example, the computation unit 1b draws the cable using information on the outline A2 of the cable after the second operation.

According to the information processing apparatus 1, upon referring to information on a plurality of operations that change the location of an object and sequentially performing a first operation through a second operation of the plurality of operations, the computation unit 1b generates information on the object outline after the second operation without generating information on the object outline for each of the first operation through an operation immediately before the second information. The computation unit 1b draws the object using the generated information on the object outline after the second operation.

In this way, it is possible to perform drawing at high speed in response to the series of operations. A specific example is as follows.

For instance, unlike a rigid body, a flexible body is instable, and its outline may change depending on its location. In some cases, in order to graphically represent such a change, each time drawing the flexible body, information on the outline of the flexible body is generated on the basis of the information on the location of the flexible body by performing a predetermined computation. Then, the flexible body is drawn. Further, since the flexible body has a complex shape, a relatively large number of parameters are used for representing the flexible body. Therefore, if all the records of the shape of the flexible body are stored for a series of operations, the storage area such as the RAM might be exhausted. For this reason, in the case of the flexible body having a complex shape, information on the outline of the flexible body may be generated each time drawing the flexible body.

In this case, however, upon verifying the motion and the like of the object by reproducing a series of operations on the object, drawing might be delayed. For example, it is difficult to express a change in the outline of the flexible body or the like with simple translation and rotation, and therefore the computational cost for generating information on the outline is relatively high. Accordingly, if computation for generating information on the outline of the flexible body is performed each time one of a series of operations is performed, it might take time until the state of the object after the plurality of operations is checked. The more complex the object to be drawn becomes, the higher the computational cost becomes, and the greater the delay in drawing might become.

In view of the above, upon sequentially performing a first operation through a second operation of a plurality of operations, the information processing apparatus 1 generates information on the object outline after the second operation, without generating information on the object outline for each of the first operation through an operation immediately before the second operation. That is, information on the object outline is not generated for the operations preceding the second operation. Thus, it is possible to reduce the overall computational cost for a series of operations. As a result, it is possible to perform drawing at high speed in response to the series of operations.

### (b) Second Embodiment

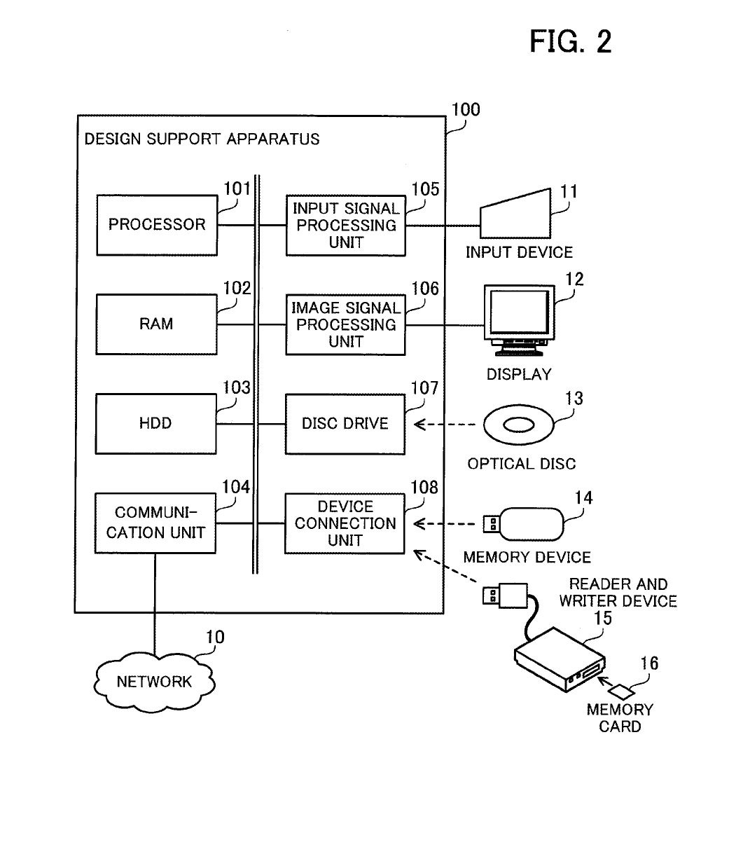

FIG. 2 illustrates an exemplary hardware configuration of a design support apparatus 100 according to a second embodiment. The design support apparatus 100 is a computer that supports design of components, products, and the like. The design support apparatus 100 provides a DMU function. The design support apparatus 100 includes a processor 101, a RAM 102, a hard disk drive (HDD) 103, a communication unit 104, an input signal processing unit 105, an image signal processing unit 106, a disc drive 107, and a device connection unit 108. Each unit is connected to a bus of the design support apparatus 100.

The processor 101 controls information processing performed by the design support apparatus 100. Examples of the processor 101 include a CPU, a GPU, a micro processing unit (MPU), a digital signal processor (DSP), an application specific integrated circuit (ASIC), a field programmable gate array (FPGA), a programmable logic device (PLD), and the like. The design support apparatus 100 may include a plurality of processors. The processor 101 may be a combination of two or more of CPU, GPU, MPU, DSP, ASIC, FPGA, PLD, and the like.

The RAM 102 serves as a primary storage device of the design support apparatus 100. The RAM 102 temporarily stores at least part of operating system (OS) programs and application programs that are executed by the processor 101. The RAM 102 also stores various types of data that are used in processing performed by the processor 101. The design support apparatus 100 may include a plurality of primary storage devices.

The HDD 103 serves as a secondary storage device of the design support apparatus 100. The HDD 103 magnetically writes data to and reads data from an internal magnetic disk. The HDD 103 stores the OS programs, application programs, and various types of data. The design support apparatus 100 may include other types of secondary storage devices such as a flash memory, a solid state drive (SSD), and the like, and may include a plurality of secondary storage devices.

The communication unit 104 is an interface capable of communicating with other computers via a network 10. The communication unit 104 may be a wired interface or a radio interface.

The input signal processing unit 105 obtains an input signal from an input device 11 connected to the design support apparatus 100, and outputs the input signal to the processor 101. Examples of the input device 11 include pointing devices, such as a mouse, a touch panel, and the like, and also include a keyboard and the like.

The image signal processing unit 106 outputs an image to a display 12 connected to the design support apparatus 100, in accordance with an instruction from the processor 101. Examples of the display 12 include a cathode ray tube (CRT) display, a liquid crystal display, and the like.

The disc drive 107 is a drive unit that reads programs and data from an optical disc 13 by using laser beams or the like. Examples of the optical disc 13 include a digital versatile disc (DVD), a DVD-RAM, a compact disc read only memory (CD-ROM), a CD-Recordable (CD-R), a CD-Rewritable (CD-RW), and the like. The disc drive 107 reads the programs and data from the optical disc 13, and stores the read programs and data in the RAM 102 or the HDD 103, in accordance with an instruction from the processor 101, for example.

The device connection unit 108 is a communication interface that connects peripheral devices to the design support apparatus 100. For example, a memory device 14 and a reader and writer device 15 may be connected to the device connection unit 108. The memory device 14 is a recording medium having a function for communicating with the device connection unit 108. The reader and writer device 15 writes data to and reads data from a memory card 16. The memory card 16 is a card-type recording medium. The device connection unit 108 reads programs and data from the memory device 14 or the memory card 16, and stores the read programs and data in the RAM 102 or the HDD 103, in accordance with an instruction from the processor 101, for example.

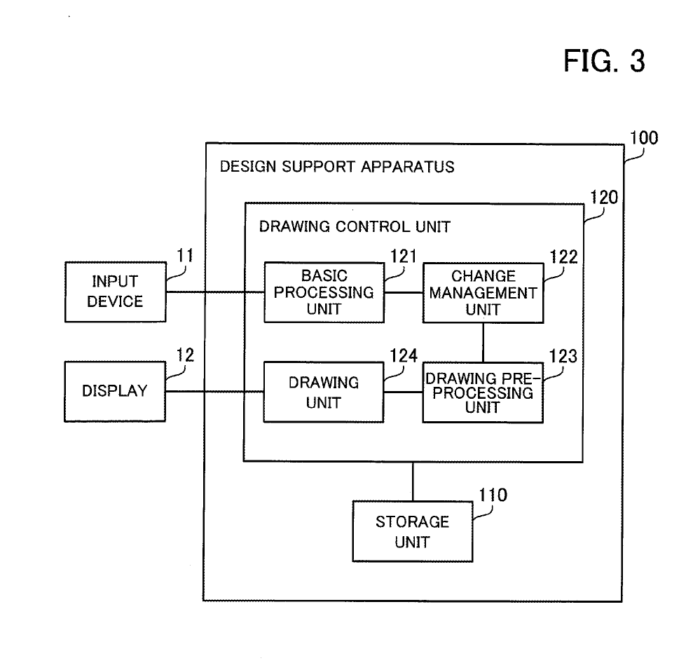

FIG. 3 illustrates an exemplary software configuration of the design support apparatus 100 according to the second embodiment. All or part of the units illustrated in FIG. 3 may be realized when the processor 101 executes a program stored in the RAM 102. The design support apparatus 100 includes a storage unit 110 and a drawing control unit 120.

The storage unit 110 stores various types of information for drawing an object. The storage unit 110 also stores information on a series of operations on an image of the object. The information on a series of operations may include operation records for reversing (for undoing) previous operations, for example. The information on a series of operations may include operation records for reproducing (for redoing) the motion of the object in animation, for example. The operation records may be referred to as an “operation history”. The storage unit 110 may be realized by the storage areas of the RAM 102 and the HDD 103.

The drawing control unit 120 receives an input of an operation with respect to the image of the object, and displays an image reflecting the operation on the display 12. The user may input to the drawing control unit 120 information on an operation on the image of the object, by operating the input device 11. Examples of operations on the image of the object include moving the object, scaling, changing the horizontal and vertical size, rotating the object (changing the attitude), changing the transmittance, changing the tone, switching between display and hide, and the like.

The drawing control unit 120 also receives an instruction for starting a series of operations on the image of the object. If the series of operations includes operations arranged from the latest to the oldest (reverse chronological order), the series of operations is undone. If the series of operations includes operations arranged from the oldest to the latest (chronological order), the series of operations is redone. The drawing control unit 120 includes a basic processing unit 121, a change management unit 122, a drawing pre-processing unit 123, and a drawing unit 124.

The basic processing unit 121 performs basic processing for drawing the object in response to an operation on the image of the object. More specifically, the basic processing unit 121 processes information on the object location. The information on the object location includes the position and attitude of the object in a virtual 3D space. The basic processing unit 121 stores an operation history in the storage unit 110. In response to an instruction for starting a series of operations, the basic processing unit 121 re-executes basic processing for the instructed series of operations, on the basis of the operation history stored in the storage unit 110.

When the basic processing unit 121 re-executes basic processing for the series of operations, the change management unit 122 merges operation contents, and generates information on a merged operation content. For example, the change management unit 122 merges a plurality of operations of the same type such that these plurality of operations are recognized as one operation. Further, for example, the change management unit 122 cancels a plurality of opposite operations such that these plurality of operations are regarded as not having been performed (the plurality of operations are regarded as not being present).

The drawing pre-processing unit 123 refers to the information generated by the change management unit 122, and performs drawing pre-processing on the merged operations. The drawing pre-processing is processing for generating information to be used for drawing. For example, in the case of drawing a flexible body, the drawing pre-processing includes processing for generating the outline of the flexible body by performing a predetermined computation on the basis of information on the location of the flexible body.

The drawing unit 124 draws the object on the basis of the information generated by the drawing pre-processing unit 123. The drawing unit 124 causes the display 12 to display the drawn image.

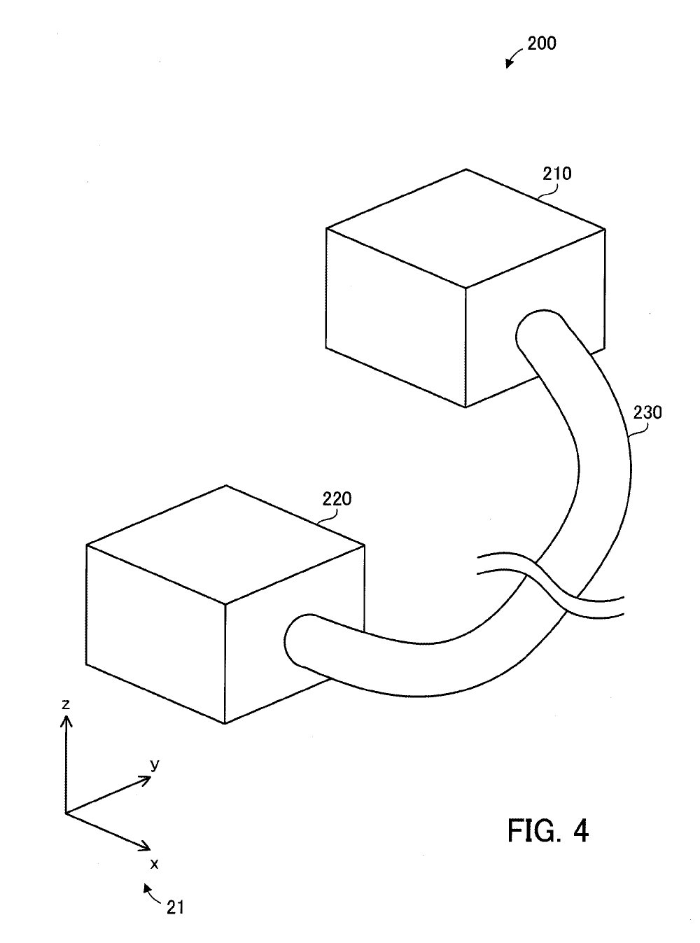

FIG. 4 illustrates an example of drawing of an assembly 200 according to the second embodiment. The assembly 200 is a group of components 210, 220, and 230 that are assembled together. The components 210 and 220 are rigid bodies. The component 230 is a flexible body. The component 230 is a cable connected to the components 210 and 220. Each of the components 210, 220, and 230 is an object arranged in a virtual 3D space. The assembly 200 may be recognized as a single object. Coordinate axes 21 are x, y, and z axes of the virtual 3D space. The assembly 200 is managed using information described below, for example.

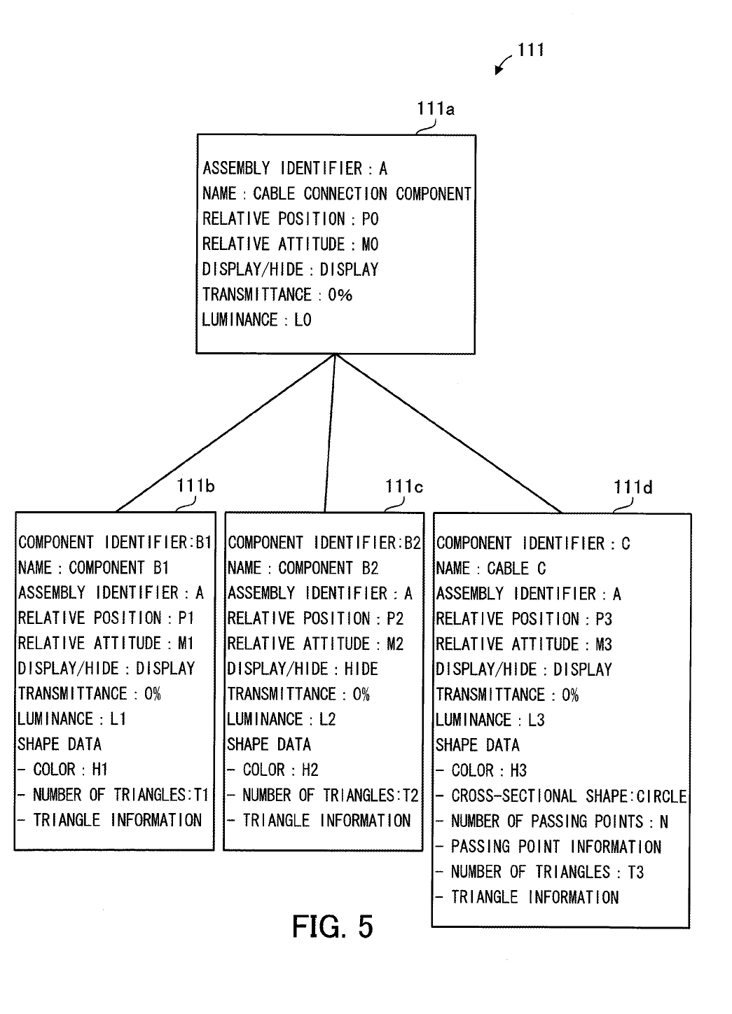

FIG. 5 illustrates an example of 3D data 111 according to the second embodiment. The 3D data 111 is stored in the storage unit 110. The 3D data 111 includes assembly data 111a, component data 111b, component data 111c, and component data 111d. The assembly data 111a is information on the assembly 200. The component data 111b, component data 111c, and component data 111d are information on the components 210, 220, and 230, respectively.

The component data 111b, component data 111c, and component data 111d are stored under the assembly data 111a in association therewith. This is because the components 210, 220, and 230 are elements of the assembly 200. In addition to the elements of the assembly 200, another assembly may be included. In this case, assembly data on the other assembly is stored under the assembly data 111a in association therewith.

The assembly data 111a contains the following items: assembly identifier, name, relative position, relative attitude, display or hide, transmittance, and luminance.

In the item “assembly identifier”, information for identifying an assembly is registered. In the item “name”, the name of the assembly is registered. In the item “relative position”, relative coordinates with respect to a predetermined point (or the origin) in the virtual 3D space are registered. In the item “relative attitude”, information on the relative attitude with respect to a predetermined coordinate axis (or an absolute coordinate axis) of the 3D space (information on rotation matrix, for example) is registered. In the item “display or hide”, information on whether to draw the assembly is registered. If “display” is registered, the assembly is drawn. If “hide” is registered, the assembly is not drawn. In the item “transmittance”, information on the transparency of the assembly is registered. The higher the transmittance is, more visible an object drawn behind the assembly becomes. In the item “luminance”, information on the luminance of the assembly is registered.

For example, in the assembly data 111a, the following information is registered for the assembly 200: “A” as the assembly identifier, “cable connection component” as the name, “P0” as the relative position, “M0” as the relative attitude, “display” as the display or hide, “0%” as the transmittance, and “L0” as the luminance.

Each of the component data 111b, component data 111c, and component data 111d contains the following items: component identifier, name, assembly identifier, relative position, relative attitude, display or hide, transmittance, luminance, and shape data.

As for the items “name”, “relative position”, “relative attitude”, “display or hide”, “transmittance”, and “luminance”, the same types of information as those in the assembly data 111a are registered, although the information registered here is information on a component. If a registration value differs between the information on the component and the information on the assembly, the information on the component is preferentially used when drawing the component. In the items “relative position” and “relative attitude”, relative position coordinates or matrices with respect to the registration values of the relative position and the relative attitude of the assembly may be registered. In these items, the same types of information as those in the assembly data 111a are registered.

In the item “shape data”, information on the location of the component and information on the outline of the component are registered. The items in the shape data differ between the rigid components and flexible components.

The shape data in each of the component data 111b and component data 111c of the rigid components 210 and 220 contains the following items: color, the number of triangles, and triangle information. In the item “color”, the color of the component is registered. In the item “the number of triangles”, the number of triangular polygons is registered. In the item “triangle information”, information on the polygons is registered. For example, in the component data 111b, the following information is registered as the shape data of the component 210: “H1” as the color, and “T1” as the number of triangles. A specific example of the triangle information will be described below.

The shape data in the component data 111d of the flexible component 230 (a cable in this embodiment) contains the following items: color, cross-sectional shape, the number of passing points, passing point information, the number of triangles, and triangle information. In the items “color”, “the number of triangles”, and “triangle information”, the same types of information as those in the component data 111b and the component data 111c are registered. In the item “cross-sectional shape”, information on the cross-sectional shape of the component 230 is registered. In the item “the number of passing points”, information on the number of passing points of the component 230 is registered. In the item “passing point information”, the coordinates of the passing points are registered. For example, in the component data 111d, the following information is registered as the shape data of the component 230: “circle” as the cross-sectional shape, “N” as the number of passing points, and “T3” as the number of triangles. Specific examples of the passing point information and the triangle information will be described below.

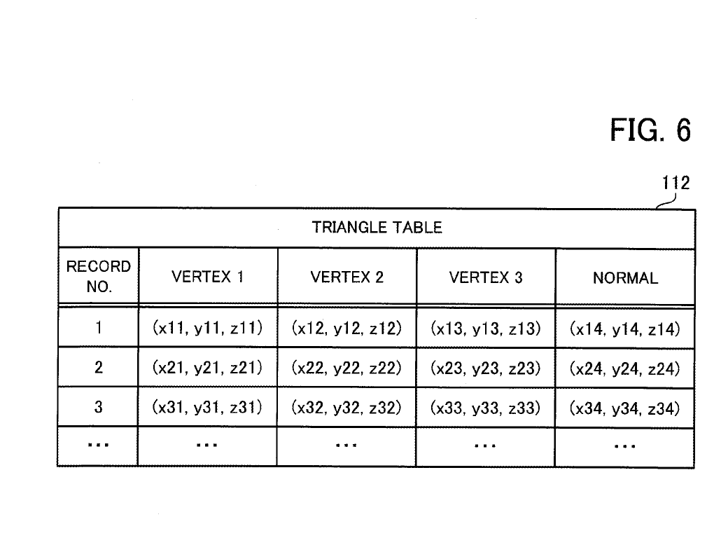

FIG. 6 illustrates an example of a triangle table 112 according to the second embodiment. The triangle table 112 is stored in the storage unit 110. The triangle table 112 is an example of triangle information in the component data 111b. The triangle table 112 contains the following items: record number, vertex 1, vertex 2, vertex 3, and normal.

In the item “record number”, a number for identifying a record of a polygon is registered. In the items “vertex 1”, “vertex 2”, and “vertex 3”, coordinates of the respective three vertices of the triangular polygon are registered. In the item “normal”, information on the normal vector of a plane containing the polygon is registered.

For example, in the triangle table 112, the following information is registered: “1” as the record number, “(x11, y11, z11)” as the vertex 1, “(x12, y12, z12)” as the vertex 2, “(x13, y13, z13)” as the vertex 3, and “(x14, y14, z14)” as the normal.

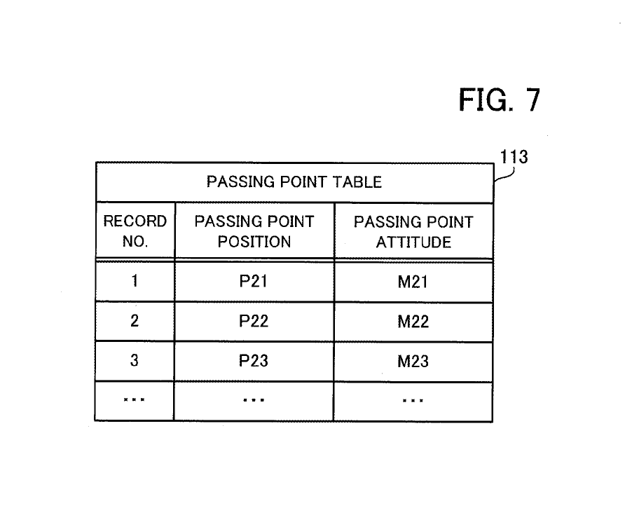

FIG. 7 illustrates an example of a passing point table 113 according to the second embodiment. The passing point table 113 is stored in the storage unit 110. The passing point table 113 is an example of passing point information in the component data 111d. The passing point table 113 contains the following items: record number, passing point position, and passing point attitude.

In the item “record number”, a number for identifying a record of a passing point is registered. In the item “passing point position”, the coordinates of the passing point are registered. In the item “passing point attitude”, information on the matrix indicating the attitude of the component 230 (cable) on the passing point is registered. For example, in the passing point table 113, the following information is registered: “1” as the record number, “P21” as the passing point position, and “M21” as the passing point attitude.

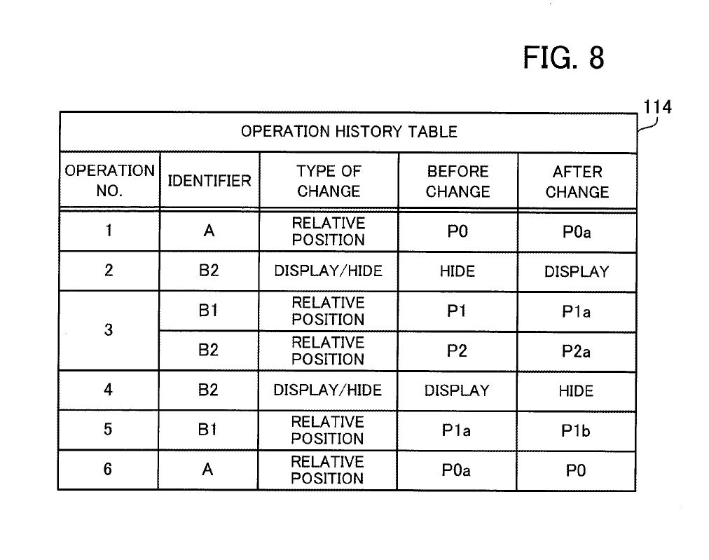

FIG. 8 illustrates an example of an operation history table 114 according to the second embodiment. The operation history table 114 is stored in the storage unit 110. The operation history table 114 contains the following items: operation number, identifier, type of change, before change, and after change.

In the item “operation number”, a number for identifying a record of an operation is registered. In the item “identifier”, an assembly identifier indicating an assembly subjected to an operation or a component identifier indicating a component subjected to an operation is registered. In the item “type of change”, information on the attribute changed by the operation is registered. In the item “before change”, a setting value of the attribute before the change is registered. In the item “after change”, a setting value of the attribute after the change is registered. Note that the terms “before change” and “after change” as used herein refer to “anterior” and “posterior” in the forward direction in time. Information registered in the items “before change” and “after change” corresponds to the information registered in the item “type of change”. The following are some examples of information registered for different types of change.

(1) type of change “relative position”: coordinates before and after the change

(2) type of change “display or hide”: “display” or “hide”

(3) type of change “attitude”: the amount of rotation before and after the change

(4) type of change “color”: color before and after the change

(5) type of change “transmittance”: transmittance before and after the change

For example, in the operation history table 114, the following operation information is registered.

As for an operation with the operation number “1”, the identifier is “A”; the type of change is “relative position”; the coordinates of the relative position before the change are “P0”; and the coordinates of the relative position after the change are “P0a”. This information indicates that the location of the assembly 200 is changed.

As for an operation with the operation number “2”, the identifier is “B2”; the type of change is “display or hide”; the setting before the change is “hide”; and the setting after the change is “display”. This information indicates that the display or hide setting for the component 220 is switched from “hide” to “display”.

As for an operation with the operation number “3”, the identifier is “B1”; the type of change is “relative position”; the coordinates of the relative position before the change are “P1”; and the coordinates of the relative position after the change are “P1a”. This information indicates that the location of the component 210 is changed. Further, as for the operation with the operation number “3”, the identifier is “B2”; the type of change is “relative position”; the coordinates of the relative position before the change are “P2”; and the coordinates of the relative position after the change are “P2a”. This information indicates that the location of the component 220 is changed. Note that, as in the case of the operation with the operation number “3”, changes may be made to a plurality of components by a single operation.

As for an operation with the operation number “4”, the identifier is “B2”; the type of change is “display or hide”; the setting before the change is “display”; and the setting after the change is “hide”. This information indicates that the display or hide setting for the component 220 is switched from “display” to “hide”.

As for an operation with the operation number “5”, the identifier is “B1”; the type of change is “relative position”; the coordinates of the relative position before the change are “P1a”; and the coordinates of the relative position after the change are “P1b”. This information indicates that the location of the component 210 is changed.

As for an operation with the operation number “6”, the identifier is “A”; the type of change is “relative position”; the coordinates of the relative position before the change are “P0a”; and the coordinates of the relative position after the change are “P0”. This information indicates that the location of the assembly 200 is changed.

Note that, in the case where the location of the component 210 or the component 220 is changed, the location of the component 230 connected to the components 210 and 220 is also changed accordingly (for example, an end of the cable is moved to another position). The component 230 may be deformed due to the change in the location thereof.

In the operation history table 114, the operations are registered chronologically in ascending order by operation number. For example, in the case of the operations with the operation numbers from “1” to “6”, the operation with the operation number “1” is the oldest operation in terms of time. The operation with the operation number “6” is the latest operation in terms of time.

For example, in the case of “undo”, the operations are performed in reverse chronological order. Accordingly, the operations may be performed in descending order by operation number as “6”, “5”, “4”, “3”, “2”, “1” (note that each operation is performed in the backward direction in terms of time such that the state after the change is shifted to the state before the change). In the case of “redo”, the operations are performed in chronological order. Accordingly, the operations may be performed in ascending order by operation number as “1”, “2”, “3”, “4”, “5”, “6” (note that each operation is performed in the forward direction in terms of time such that the state before the change is shifted to the state after the change).

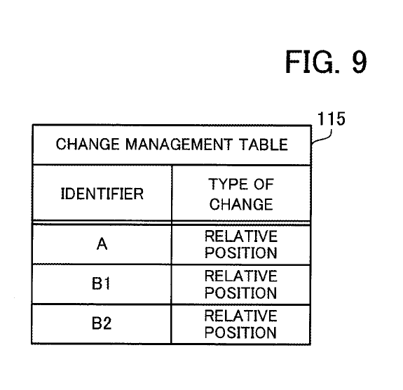

FIG. 9 illustrates an example of a change management table 115 according to the second embodiment. The change management table 115 is an example of information on a merged operation content generated by the change management unit 122 for the series of operation contents. Each single record in the change management table 115 may be referred to as a “change record”. The change management table 115 is stored in the storage unit 110. The change management table 115 contains the following items: identifier, and type of change.

In the item “identifier”, an assembly identifier indicating an assembly subjected to an operation or a component identifier indicating a component subjected to an operation is registered. In the item “type of change”, information on the attribute changed by the operation is registered.

For example, in the change management table 115, the following information is registered: “A” as the identifier, and “relative position” as the type of change. This information indicates an operation content resulting from merging the same types of operations for the assembly 200. More specifically, this information indicates that the “relative position” is changed. In the change management table 115, records of the component 210 (identifier “B1”) and the component 220 (identifier “B2”) are registered. The type of change of both records is “relative position”.

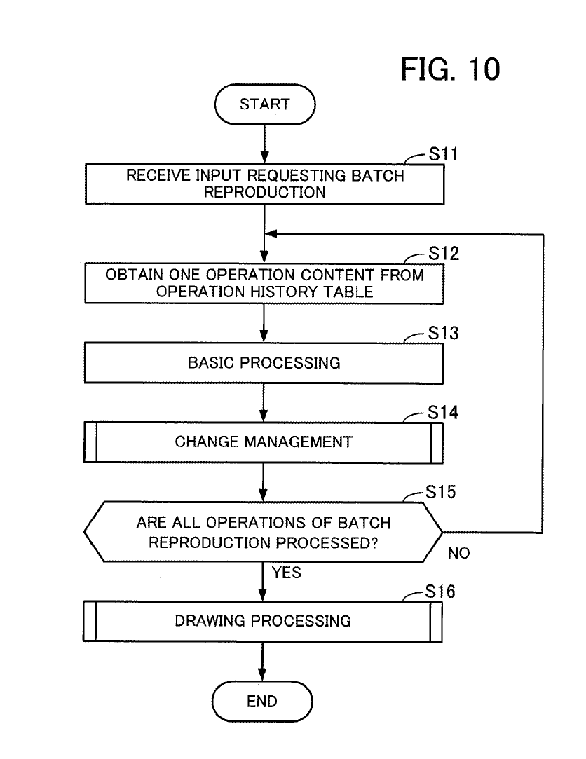

FIG. 10 is a flowchart illustrating an example of a process according to the second embodiment. In the following, the process illustrated in FIG. 10 will be described in order of step number. Note that it is assumed that, at the point immediately before step S11, entries of the above-described operation numbers “1” through “6” are present in the operation history table 114 stored in the storage unit 110. Further, it is assumed that, at the point immediately before step S11, the 3D data 111 after the operation of the operation number “6” out of these entries is managed.

(Step S11) The basic processing unit 121 receives an input requesting batch reproduction. For example, the user may enter an input requesting batch reproduction on the design support apparatus 100 by operating the input device 11. The input requesting batch reproduction may contain, for instance, information that specifies a range of operation numbers in the operation history table 114 and their order. For example, the information specifies the operation numbers “6” through “1” as a range of operation numbers, and specifies descending order (undo) as their order.

(Step S12) The basic processing unit 121 obtains one of the operation contents specified by the input requesting batch reproduction, from the operation history table 114 in the specified order. One operation content corresponds to one operation number. In the case of performing operations with the operation numbers “6” through “1” in descending order, the record of the operation number “6” is obtained first, for example.

(Step S13) The basic processing unit 121 performs basic processing so as to update part of the 3D data 111. For example, the basic processing unit 121 processes information on the object location. More specifically, in the case of the operation with the operation number “6”, an operation is performed on the assembly identifier “A”. Further, in the case of undoing the operation with the operation number “6”, the state after the change is returned to the state before the change indicated in the record of the operation number “6” in the operation history table 114. That is, the relative position “P0” in the assembly data 111a is changed to “P0a”. Further, in the case of undoing the operation with the operation number “5”, an operation is performed on the component identifier “B1”. Thus, similarly, the relative position “P1b” in the component data 111b is changed to “Plan. The basic processing unit 121 may update each information item (such as “the number of triangles”, “triangle information”, and the like) in the shape data for each of the components 210 and 220. This is because each of the components 210 and 220 is a rigid body and is not deformed by a location change. That is, each information item in the shape data may be updated by performing simple computation, such as translation, rotation, and the like, and therefore the computational cost is relatively low. The basic processing unit 121 may update “the number of passing points” and “passing point information” for the component 230. However, the basic processing unit 121 does not update “the number of triangles” and “triangle information” for the component 230. This is because the component 230 is a flexible body and is deformed by a location change, and therefore the computational cost is relatively high.

(Step S14) The change management unit 122 performs a change management process for the operation obtained in step S12. The change management process is for merging operation contents of the series of operations specified in step S11. With this change management process, the change management unit 122 registers a new record into or deletes a record from the change management table 115.

(Step S15) The basic processing unit 121 determines whether all the operations included in the series of operations specified in step S11 are processed. If all the operations are processed, the process proceeds to step S16. If there is an operation that is not processed, the process returns to step S12.

(Step S16) The drawing pre-processing unit 123 performs drawing pre-processing on the basis of the change management table 115, and updates the 3D data 111 (part of the 3D data 111 not updated in S13). For example, the drawing pre-processing unit 123 generates information indicating the outline of the flexible body. The drawing unit 124 draws an image of the assembly 200 on the basis of the 3D data 111 updated by the drawing pre-processing unit 123, and causes the display 12 to display the resulting image.

In this way, only the basic processing is performed on all the operations included in the series of operations. After that, drawing pre-processing and drawing processing are performed only one time. Next, the procedure of step S14 and S16 of FIG. 10 will be described. First, the procedure of step S14 will be described.

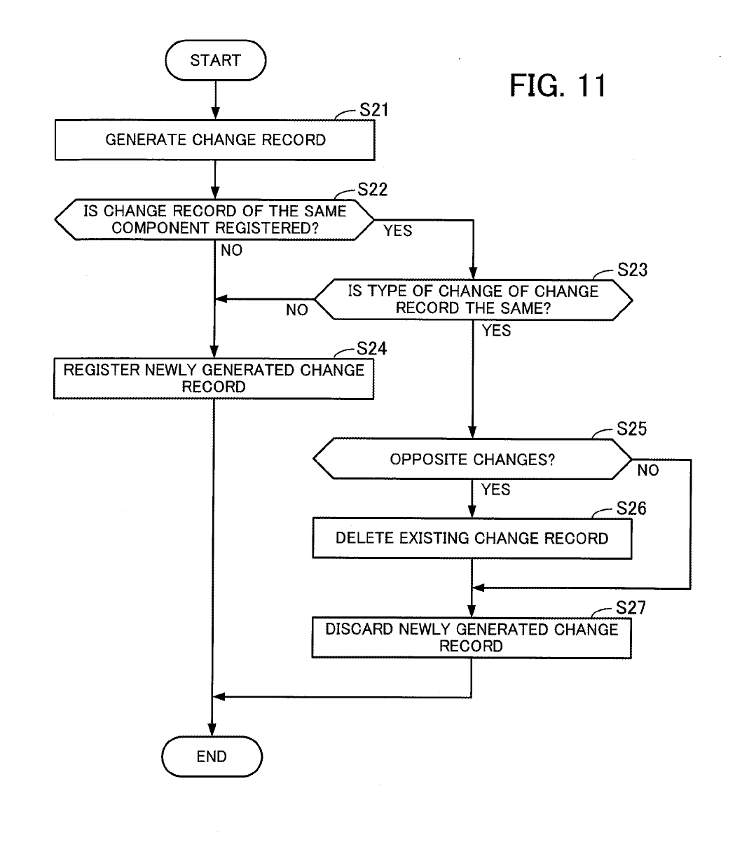

FIG. 11 is a flowchart illustrating an example of change management according to the second embodiment. In the following, the process illustrated in FIG. 11 will be described in order of step number.

(Step S21) The change management unit 122 generates a change record for the operation obtained in step S12.

(Step S22) The change management unit 122 refers to the change management table 115 stored in the storage unit 110, and determines whether a change record (change information) of the same component is registered (i.e., determines whether a change record of the component subjected to the operation obtained in step S12 is registered). If a change record of the same component is registered, the process proceeds to step S23. If a change record of the same component is not registered, the process proceeds to step S24. A determination on whether a change record of the same component is registered may be made by comparing the identifier indicating the subject of the operation obtained in step S12 to the identifier registered in the change management table 115. If there is a change record that has the identifier indicating the subject of that operation in the change management table 115, a change record of the same component is determined to be registered. If there is no change record that has the identifier indicating the subject of that operation in the change management table 115, a change record of the same component is determined not to be registered.

(Step S23) The change management unit 122 determines whether, among one or more change records of the same component registered in the change management table 115, there is a change record whose type of change is the same as that of the change record generated in step S21. If a record of the same change type is present, the process proceeds to step S25. If a record of the same change type is not present, the process proceeds to step S24.

(Step S24) The change management unit 122 registers the change record newly generated in step S21 in the change management table 115. Then, the process ends.

(Step S25) The change management unit 122 determines whether the operation indicated in the change record generated in step S21 and the operation indicated in the change record of the same component and the same change type registered in the change management table 115 are opposite changes. If the operations are opposite changes, the process proceeds to step S26. If the operations are not opposite changes, the process proceeds to step S27. Opposite changes are changes for switching between on and off. For example, opposite changes may be changes for switching between display and hide.

(Step S26) The change management unit 122 deletes the change record of the same component and the same change type as those of the change record generated in step S21 from the change management table 115.

(Step S27) The change management unit 122 discards the change record generated in step S21. Then, the process ends.

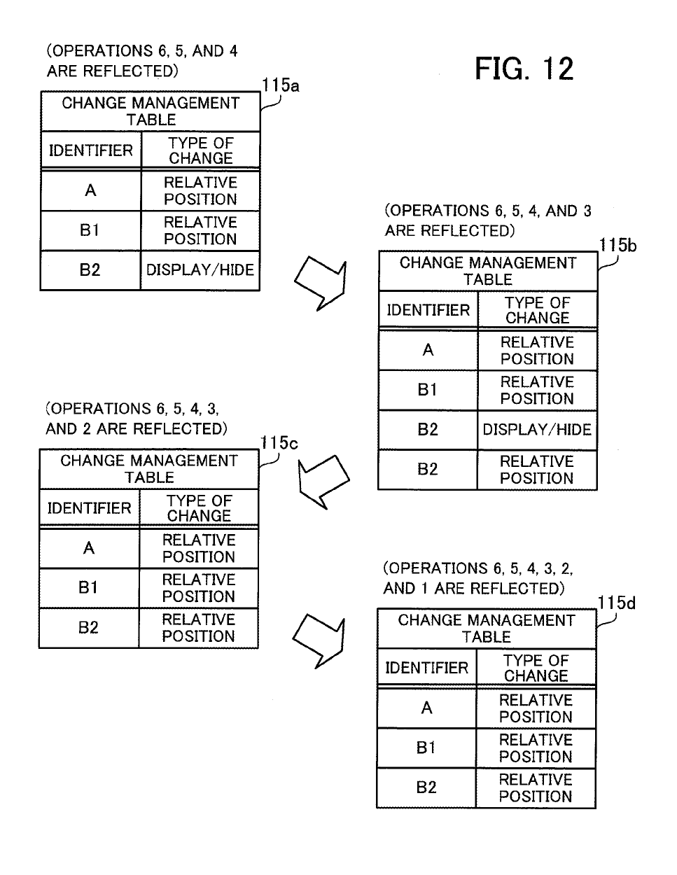

FIG. 12 illustrates an example of change management according to the second embodiment. FIG. 12 illustrates how the change management table 115 is updated in the case where the operations with the operation numbers “6” through “1” in the operation history table 114 of FIG. 8 are performed in descending order (i.e., undone). A change management table 115a is obtained when the operations with the operation numbers “6”, “5”, and “4” are sequentially reflected by the procedure illustrated in FIG. 11. A change management table 115b is obtained when the operation with the operation number is reflected in the change management table 115a. The change management table 115b is generated in the following manner.

According to the operation history table 114, the operation number “3” includes an operation performed on the (component) identifier “B1” and its type of change is “relative position”. Accordingly, the change management unit 122 generates a change record with the identifier “B1” and the type of change “relative position” for this operation (step S21). On the other hand, the change management table 115a contains a change record with the (component) identifier “B1” (Yes in step S22). Further, the type of change of this change record is “relative position” (Yes in step S23). These operations with the type of change “relative position” are not operations for switching between on and off, and therefore are not opposite changes (No in step S25). Accordingly, the change management unit 122 discards only the newly generated change record (step S27).

Similarly, according to the operation history table 114, the operation number “3” includes an operation performed on the (component) identifier “B2” and its type of change is “relative position”. Accordingly, the change management unit 122 generates a change record with the identifier “B2” and the type of change “relative position” for this operation (step S21). On the other hand, the change management table 115a contains a change record with the (component) identifier “B2” (Yes in step S22). Further, the type of change of this change record is not “relative position” but is “display or hide” (No in step S23). Accordingly, the change management unit 122 registers the newly generated change record (the identifier “B2” and the type of change “relative position”) in the change management table 115a (step S24). Thus, the change management table 115b is generated.

A change management table 115c is obtained when the operation with the operation number “2” is further reflected in the change management table 115b. The change management table 115c is generated in the following manner.

According to the operation history table 114, the operation number “2” is an operation performed on the (component) identifier “B2” and its type of change is “display or hide”. Accordingly, the change management unit 122 generates a change record with the identifier “B2” and the type of change “display or hide” for this operation (step S21). On the other hand, the change management table 115b contains a change record with the (component) identifier “B2” (Yes in step S22). Further, the type of change of this change record is “display or hide” (Yes in step S23). These operations with the type of change “display or hide” are operations for switching between on and off, and therefore are opposite changes (Yes in step S25). Accordingly, the change management unit 122 deletes the change record with the identifier “B2” and the type of change “display or hide” from the change management table 115b (step S26). Further, the change management unit 122 also discards the newly generated change record (step S27). Thus, the change management table 115c is generated.

A change management table 115d is obtained when the operation with the operation number “1” is reflected in the change management table 115c. The change management table 115d is generated in the following manner.

According to the operation history table 114, the operation number “1” is an operation performed on the (assembly) identifier “A” and its type of change is “relative position”. Accordingly, the change management unit 122 generates a change record with the identifier “A” and the type of change “relative position” for this operation (step S21). On the other hand, the change management table 115c contains a change record with the (assembly) identifier “A” (Yes in step S22). Further, the type of change of this change record is “relative position” (Yes in step S23). These operations with the type of change “relative position” are not opposite changes (No in step S25). Accordingly, the change management unit 122 discards only the newly generated change record (step S27).

In this way, the change management unit 122 merges the series of operations. Thus, it is possible to reduce the number of operations to be processed by the drawing pre-processing unit 123.

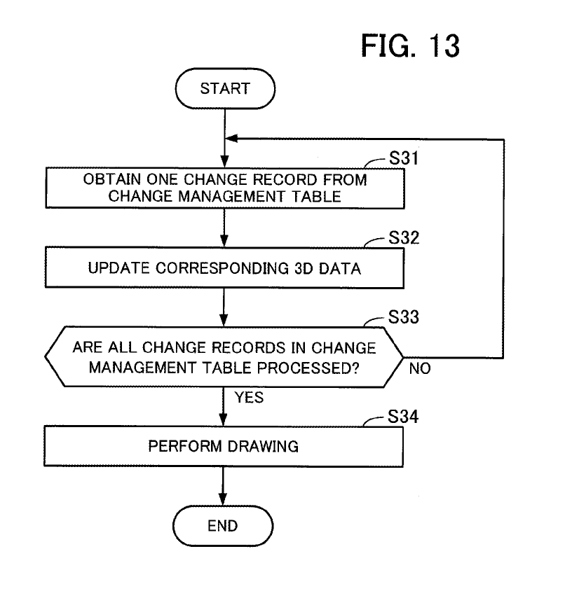

FIG. 13 is a flowchart illustrating an example of drawing processing according to the second embodiment. In the following, the process illustrated in FIG. 13 will be described in order of step number.

(Step S31) The drawing pre-processing unit 123 obtains one change record from the change management table 115 stored in the storage unit 110.

(Step S32) The drawing pre-processing unit 123 updates 3D data of a component corresponding to the change record. The drawing pre-processing unit 123 may perform either one of the following two operations (1) and (2), for example (in the case of the component 230). (1) If the number of passing points and the passing point information are not updated for the component 230 in step S13, the drawing pre-processing unit 123 updates the number or passing points and the passing point information on the basis of the locations of the components 210 and 220. Further, the drawing pre-processing unit 123 performs predetermined computation on the basis of the updated number of passing points and passing point information and on the basis of the cross-sectional shape so as to update the number of triangles and the triangle information of the component 230. (2) If the number of passing points and the passing point information are updated for the component 230 in step S13, the drawing pre-processing unit 123 performs predetermined computation on the basis of the updated number of passing points and passing point information and on the basis of the cross-sectional shape so as to update the number of triangles and the triangle information of the component 230.

(Step S33) The drawing pre-processing unit 123 determines whether the operation of step S32 is performed on all the change records registered in the change management table 115. If all the change records are processed, the process proceeds to step S34. If there is a change record that is not processed, the process returns to step S31.

(Step S34) The drawing unit 124 performs drawing on the basis of the 3D data updated by the drawing pre-processing unit 123, and causes the display 12 to display the resulting image.

In this way, the drawing pre-processing unit 123 performs drawing pre-processing on the basis of the change management table 115. The drawing pre-processing unit 123 may perform drawing pre-processing only for the change records registered in the change management table 115. Thus, the processing load on the drawing pre-processing unit 123 is reduced.

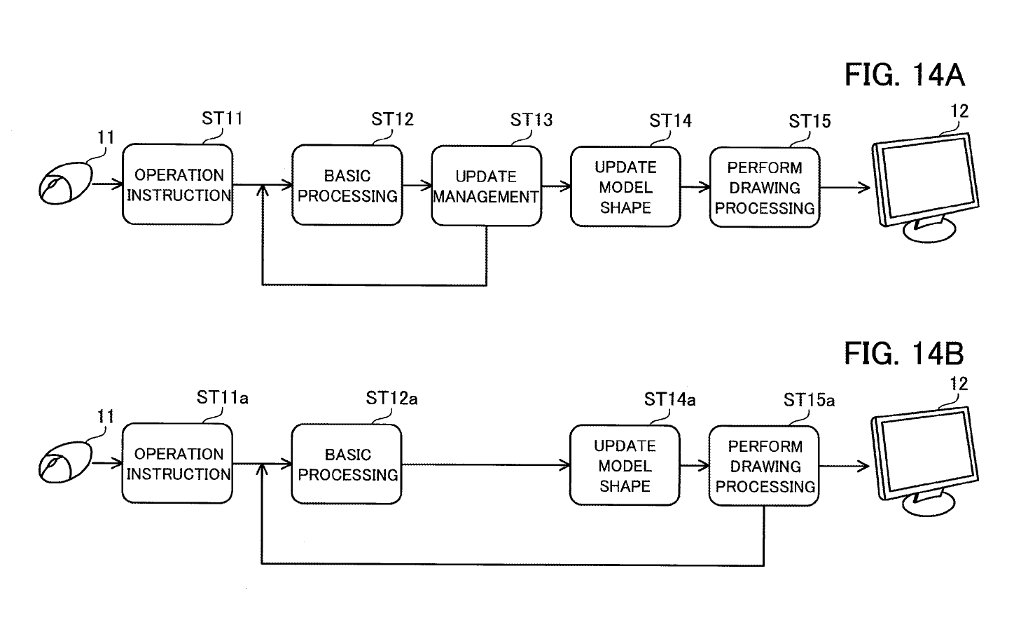

FIGS. 14A and 14B illustrate a comparison between the process of the second embodiment and another process. FIG. 14A illustrates the process of the second embodiment. FIG. 14B illustrates the other process. In the following, the processes illustrated in FIGS. 14A and 14B will be described in order of step number.

The process of FIG. 14A is as follows. First, the design support apparatus 100 receives an instruction for performing a series of operations (step ST11). For example, this instruction is input to the design support apparatus 100 by a predetermined operation input by the user using the input device 11.

The design support apparatus 100 performs basic processing (step ST12). The basic processing may include changing the relative position, the relative attitude, display or hide, the transmittance, and the luminance in the 3D data 111, changing all the items in the shape data of the solid body, and changing the number of passing points and the passing point information in the shape data of the flexible body, for example. However, at least one of the items of the shape data of the rigid body and the items (the number of passing point and the passing point information) of the shape data of the flexible body does not have to be changed. The basic processing does not include changing the number of triangles and the triangle information in the shape data of the flexible body.

The design support apparatus 100 performs update management (step ST13). The update management is a process for merging operation contents of the series of operations specified in step ST11. A plurality of operations are merged into one operation. Further, the opposite operations are cancelled out, so that the opposite operations are regarded as not being present.

The design support apparatus 100 repeats steps ST12 and ST13 for each of the specified series of operations.

After performing the update management process for all the operations included in the series of operations, the design support apparatus 100 updates the model shape (drawing pre-processing) (step ST14). That is, information in the 3D data 111 not updated in step ST12 is updated. For example, the shape data of the flexible component 230 is updated on the basis of the information such as the relative positions of the rigid components 210 and 220. Alternatively, the number of triangles and the triangle information of the flexible component 230 are updated on the basis of the cross-sectional shape, the number of passing points, and the passing point information contained in the shape data of the component 230. Thus, information on the outline of the component 230 is generated.

The design support apparatus 100 draws an image of the assembly 200 on the basis of the information on the outline, and causes the display 12 to display the resulting image (step ST15).

The process of FIG. 14B is as follows. For ease of explanation, an apparatus that performs the process of FIG. 14B is referred to as a “design support apparatus”. First, the design support apparatus receives an instruction for performing a series of operations (step ST11a). This instruction is input in the same manner as in step ST11. The design support apparatus performs basic processing (step ST12a). This basic processing is performed in the same manner as in step ST12. The design support apparatus updates the model shape (step ST14a). Thus, information on the outline of the drawing target object is generated. The design support apparatus draws an image of the drawing target object on the basis of the information on the outline, and causes the display 12 to display the resulting image (step ST15a). The design support apparatus repeats steps ST12a, ST14a, and ST15a for each of the specified series of operations.

As illustrated in FIG. 14B, information on the outline of the flexible body or the like may be generated each time drawing is performed for one operation. In this case, however, when verifying the motion and the like of the object by reproducing a series of operations, drawing might be delayed. For example, if computation for generating information on the outline of the flexible body is performed each time one of a series of operations is performed, it might take time to present the user the state of the object after the plurality of operations such that the user checks the state of the object. The more complex the object to be drawn becomes, the higher the computational cost becomes, and the greater the delay in drawing might become.

In view of the above, upon performing a series of operations, the design support apparatus 100 updates the model shape (that is, updates information on the shape of the object) one time, on the basis of the results of basic processing obtained after the series of operations. Thus, it is possible to reduce the overall computational cost for the series of operations compared to the case where the model shape is updated each time one of the series of operations is performed. As a result, it is possible to perform drawing at high speed in response to the series of operations. Further, the user may quickly check the state of the object after the series of operations. That is, the user may perform a verification process efficiently.

Further, a plurality of operations to be checked may be selected from the series of operations specified by the user. In this case, for the selected operations, the design support apparatus 100 generates information on the object outline and performs drawing. For the other operations, the design support apparatus 100 only generates information on the object location, and does not perform drawing. Thus, the user may efficiently perform verification for the series of operations with reference to the image that is drawn intermittently.

In the second embodiment, the location of the component 230 is indirectly changed by changing the locations of the components 210 and 220. However, the process of the second embodiment may also be employed in the case where the location of the component 230 is directly changed. Further, the location of the component 230 is indirectly changed not only by changing the locations of the components 210 and 220, but also by other factors. For example, in the case where a tool, the hand of an operator, or the like is inserted as an object, the location of the component 230 may be indirectly changed by the load applied to the component 230 by the tool, the hand, or the like. The process of the second embodiment may also be employed in this case.

### (c) Third Embodiment

Hereinafter, a third embodiment will be described. The following mainly describes the differences from the second embodiment, and description of the common features will be omitted.

In the second embodiment, in the change management process, if opposite changes are made, corresponding operations are regarded as not having been occurred. In addition to that, in the basic processing, the amount of change in an attribute value may be recorded when the attribute value is changed. Thus, it is possible to extend the range of operations that may be cancelled out. The third embodiment provides this function.

The hardware and software of a design support apparatus of the third embodiment are the same as those of the design support apparatus 100 of the second embodiment illustrated in FIGS. 2 and 3. Thus, in the third embodiment, elements corresponding to those in FIGS. 2 and 3 bear the same names and the same reference numerals. However, the third embodiment differs from the second embodiment in that, upon changing an attribute value, the change management unit 122 records the amount of change in a change management table, and merges operation contents on the basis of the change management table. Accordingly, in place of the change management table 115 of the second embodiment, a change management table 116 in which the amount of change in the attribute value may be registered is used.

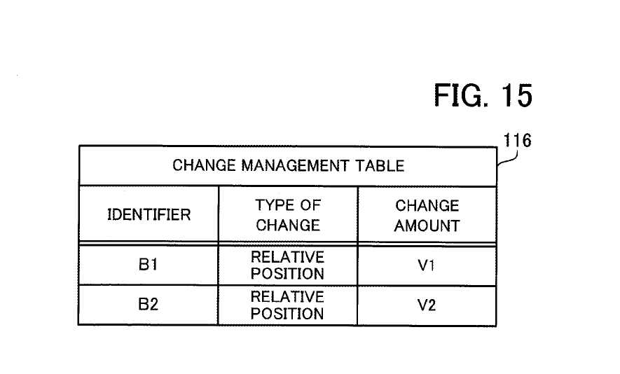

FIG. 15 illustrates an example of the change management table 116 according to the third embodiment. The change management table 116 is an example of information on a merged operation content generated by the change management unit 122 for a series of operation contents. Each single record in the change management table 116 may be referred to as a “change record”. The change management table 116 is stored in the storage unit 110. The change management table 116 contains the following items: identifier, type of change, and change amount.

In the item “identifier”, an assembly identifier indicating an assembly subjected to an operation or a component identifier indicating a component subjected to an operation is registered. In the item “type of change”, information on the attribute changed by the operation is registered. In the item “change amount”, information on the integrated value of the amount of change in the attribute value is registered. For instance, if the type of change is the relative position, a vector indicating the amount of change in the position is registered. If the type of change is the relative attitude, a matrix indicating the amount of change in the rotation amount is registered. If the type of change is the luminance, a value indicating the amount of change in the luminance is registered.

For example, in the change management table 116, the following information is registered: “B1” as the identifier, “relative position” as the type of change, and “V1” as the change amount. This information indicates an operation content for the component 210 resulting from merging the contents of a series of operations (or operations up to a certain point). More specifically, this information indicates that the “operation position” is changed. Further, this information indicates that the amount of change by the series of operations (or operations up to a certain point) is “V1”.

Next, a description will be given of the procedure of the third embodiment. Examples of general processing and drawing processing of the third embodiment are the same as those of the second embodiment illustrated in FIGS. 10 and 13, and therefore will not be further described herein. The third embodiment differs from the second embodiment in the process of change management.

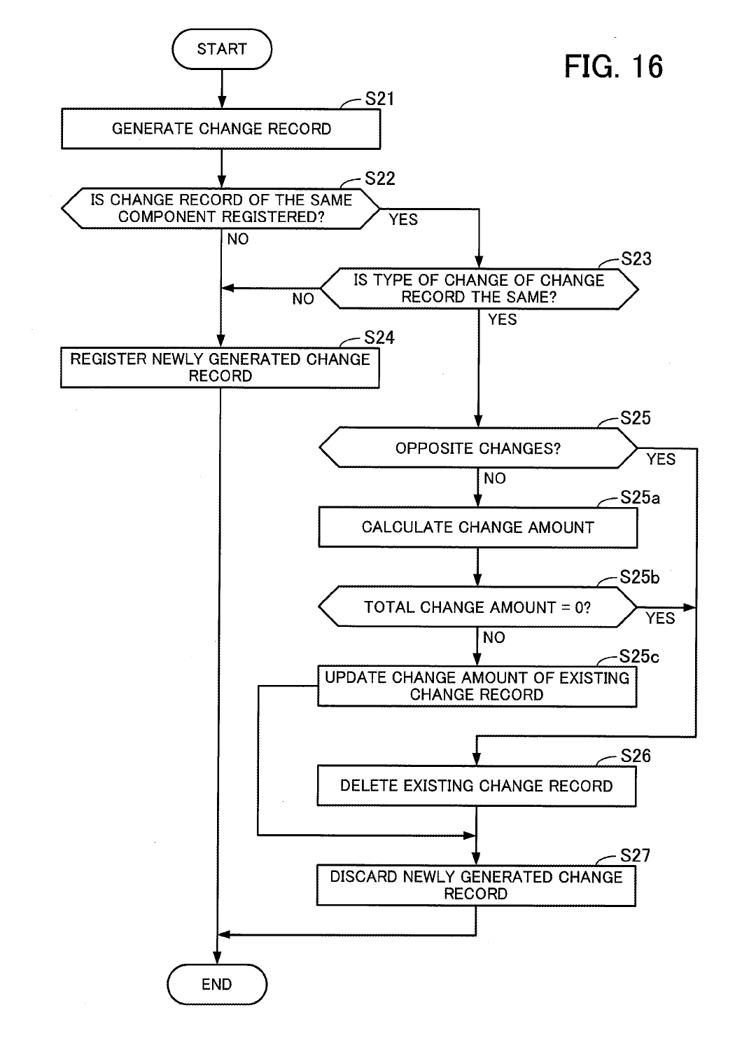

FIG. 16 is a flowchart illustrating an example of change management according to the third embodiment. In the following, the process illustrated in FIG. 16 will be described in order of step number. Steps excluding steps S25a, S25b, and S25c are the same as those denoted by the same step numbers in FIG. 11. However, the change management unit 122 performs each step with reference to the change management table 116. Further, in the third embodiment, if the operations are determined not to be opposite changes in step S25 (No in step S25), the process proceeds to step S25a.

(Step S25a) The change management unit 122 calculates the amount of change resulting from the operation. More specifically, the change management unit 122 obtains the amount of change by calculating the difference between the attribute values before and after the change in the operation history table 114 stored in the storage unit 110. For example, in the case of an undo operation, the value after change is set back to the value before the change. In the case of the operation number “6”, a vector “V0” indicating the difference between the coordinates “P0” and “P0a” of the relative positions (a vector directing from the coordinates “P0” to “P0a”) is the change amount. In the case of a redo operation, the direction is reversed.

(Step S25b) The change management unit 122 refers to the change management table 116 stored in the storage unit 110, and determines whether the total of a registered change amount and the current change amount is 0. If the total is 0, the process proceeds to step S26. If the total is not 0, the process proceeds to step S25c. For example, when the registered change amount of the type of change “relative position” is “V1”, and the current change amount is “−V1”, the result of adding these amounts is 0.

(Step S25c) The change management unit 122 registers the value of the total change amount calculated in step S25b in the item “change amount” of the corresponding change record in the change management table 116. Thus, the change amount of the corresponding change record is updated to an integrated value obtained after merging the operations up to this point. Then, the process proceeds to step S27.

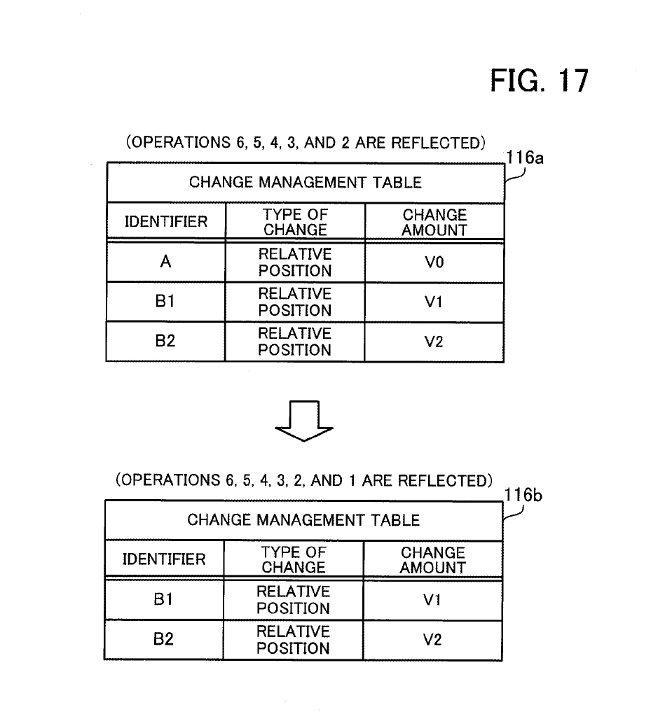

FIG. 17 illustrates an example of change management according to the third embodiment. FIG. 17 illustrates how the change management table 116 is updated in the case where the operations with the operation numbers “6” through “1” in the operation history table 114 of FIG. 8 are performed in descending order (i.e., undone). A change management table 116a is obtained when the operations with the operation numbers “6”, “5”, “4”, “3”, and “2” are sequentially reflected by the procedure illustrated in FIG. 16. With respect to the operation number “6”, the amount of change for directing from the coordinates “P0” to “P0a” upon an undo operation is the vector “V0”. A change management table 116b is obtained when the operation with the operation number “1” is reflected in the change management table 116a. The change management table 116b is generated in the following manner.

According to the operation history table 114, the operation number “1” includes an operation performed on the (assembly) identifier “A” and its type of change is “relative position”. Accordingly, the change management unit 122 generates a change record with the identifier “A” and the type of change “relative position” for this operation (step S21). On the other hand, the change management table 116a contains a change record with the (assembly) identifier “A” (Yes in step S22). Further, the type of change of this change record is “relative position” (Yes in step S23). The type of change of both change records is “relative position”, and therefore the operations are not opposite changes (No in step S25). Then, the change management unit 122 calculates the amount of change mad by the current operation. More specifically, undoing the operation with the operation number “1” is to change the coordinates “P0a” to the coordinates “P0”. Thus the change amount is a vector “−V0” (step S25a). The change management unit 122 adds the change amount “V0” of the (assembly) identifier “A” in the change management table 116a and the calculated change amount “−V0”. The obtained result is 0 (Yes in step S25b). Accordingly, the change management unit 122 deletes the change record with the identifier “A”, the type of change “relative position”, and the change amount “V0” from the change management table 116a (step S26). Further, the change management unit 122 also discards the generated change record (step S27). Thus, the change management table 116b is generated.

In this way, the change management unit 122 merges the series of operations. In particular, in addition to opposite operations, the amount of change in the operation position and the like are registered. Then, if the amount of change is cancelled out, the corresponding operations are regarded as not being present. Thus, compared to the second embodiment, it is possible to further reduce the number of operations to be processed by the drawing pre-processing unit 123.

Moreover, since the amount of change in each attribute is registered in the change management table 116, it is possible to reduce the processing load in, for example, step S13 (the basic processing) of FIG. 10. For instance, the operation of step S13 may be skipped. Thus, it is possible to reduce the processing cost, and to perform drawing at higher speed in response to the series of operations.

### (d) Fourth Embodiment

Hereinafter, a fourth embodiment will be described. The following mainly describes the differences from the second and third embodiments, and description of the common features will be omitted.

The fourth embodiment provides a function for controlling the order in which an assembly is drawn. With this function, certain portions of the assembly may be drawn at high speed. The hardware of a design support apparatus 100a of the fourth embodiment is the same as that of the design support apparatus 100 of the second embodiment illustrated in FIG. 2.

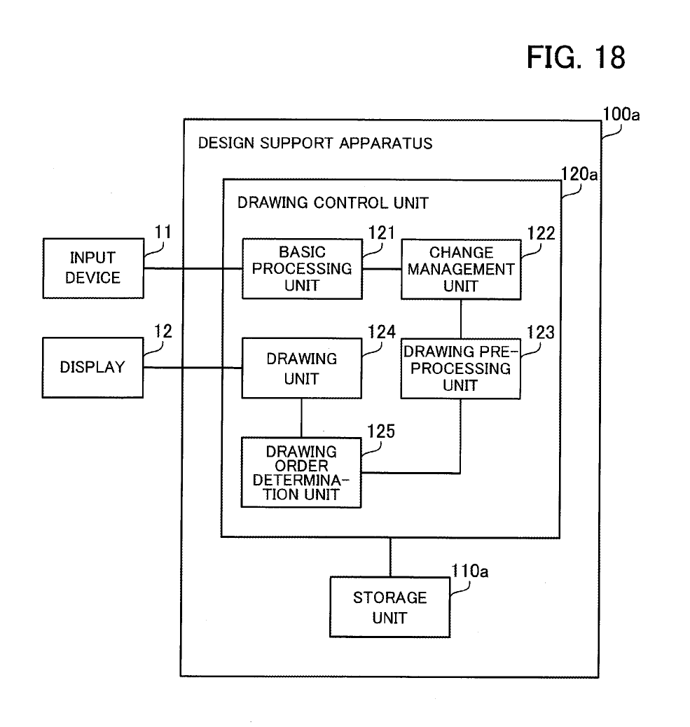

FIG. 18 illustrates an exemplary software configuration of the design support apparatus 100a according to the fourth embodiment. All or part of the units illustrated in FIG. 18 may be realized when a processor 101 executes a program stored in a RAM 102. The design support apparatus 100a includes a storage unit 110a and a drawing control unit 120a.

The storage unit 110a stores various types of information for drawing an object. The storage unit 110a stores the same information as that stored in the storage unit 110 of the second or third embodiment. Further, the storage unit 110a stores information on a plurality of regions (which may be referred to as “blocks”) in a virtual 3D space.

The drawing control unit 120a performs drawing control similar to that performed by the drawing control unit 120 of the second or third embodiment. The drawing control unit 120a includes a basic processing unit 121, a change management unit 122, a drawing pre-processing unit 123, a drawing unit 124, and a drawing order determination unit 125. The basic processing unit 121, the change management unit 122, the drawing pre-processing unit 123, and the drawing unit 124 in this embodiment are identical to those bearing the same names and the same reference numerals in the second embodiment illustrated in FIG. 3. However, the fourth embodiment differs from the second and third embodiments in that the drawing order determination unit 125 is provided between the drawing pre-processing unit 123 and the drawing unit 124.

When 3D data 111 is updated by the drawing pre-processing unit 123, the drawing order determination unit 125 refers to the storage unit 110a, and determines the order in which blocks are drawn. The drawing order determination unit 125 specifies, in the field that is currently being drawn, a point (hereinafter referred to as an “attention point”) on which the attention of the user is focused, on the basis of the current position of the mouse pointer, the viewpoint position, the line of sight, and the like. The attention point may be a point which the user is expected to be currently working on, or a point which the user is likely to be currently working on. Note that, information on the viewpoint position and information on the line of sight may include information that is commonly used as a parameter for determining the visual field in a virtual 3D space.

The drawing order determination unit 125 determines the drawing order such that a block containing the attention point is drawn with the highest priority, and blocks closer to the attention point are drawn with higher priority. The drawing order determination unit 125 reports the determination result of the drawing order to the drawing unit 124. The drawing unit 124 performs drawing in the determined drawing order.

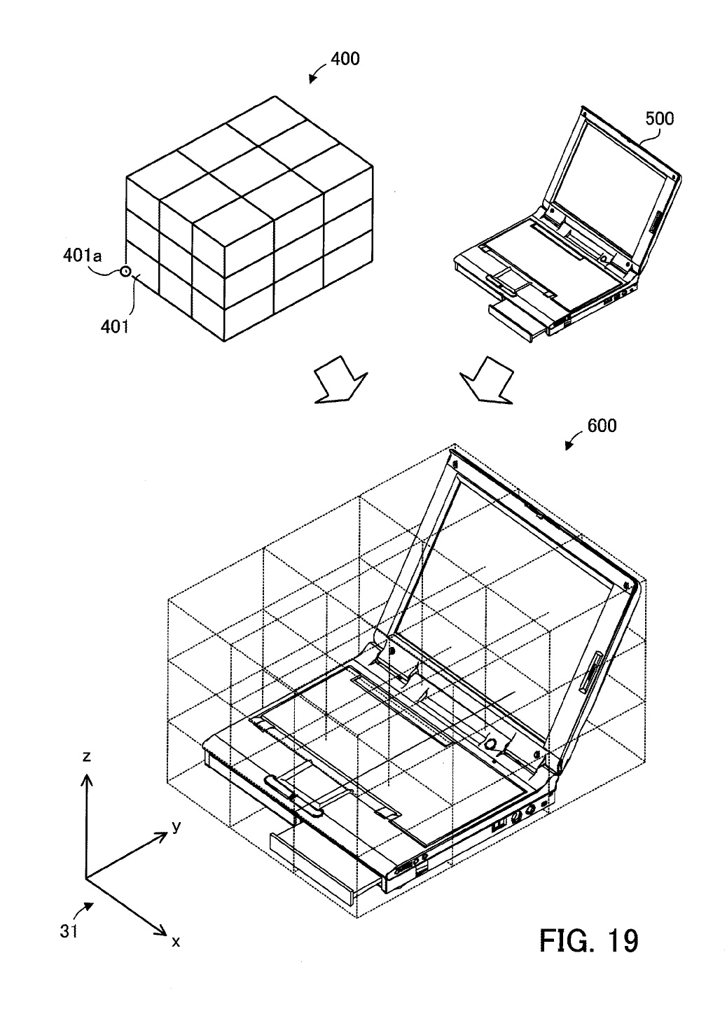

FIG. 19 illustrates examples of blocks according to the fourth embodiment. A block group 400 is a collection of blocks. The block group 400 includes a block 401. The block 401 is a single block. The block 401 has a vertex 401a. The vertex 401a is located at the lower left corner of the block 401 in FIG. 19. The block group 400 includes 27 blocks, for example. An assembly 500 is an assembly of components of a laptop personal computer.

An image 600 represents the assembly 500 with the block group 400 superimposed thereon in a virtual 3D space. Each part of the assembly 500 belongs to one or more of the blocks of the block group 400. Note that coordinate axes 31 are x, y, and z axes of the virtual 3D space. The block group 400 is managed using information described below, for example.

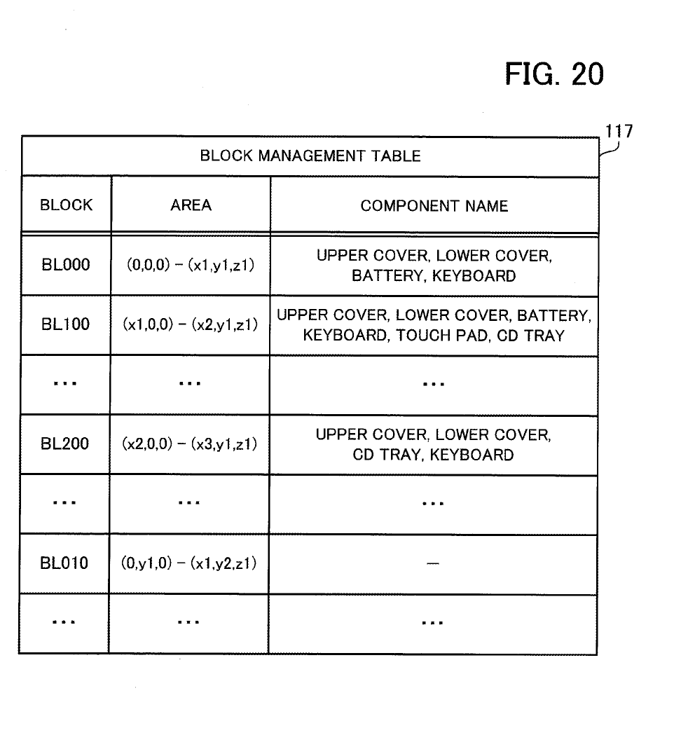

FIG. 20 is an example of a block management table 117 according to the fourth embodiment. The block management table 117 is stored in the storage unit 110a. The block management table 117 contains the following items: block, area, and component name.

In the item “block”, information for identifying a block is registered. In the item “area”, the range of coordinates belonging to the block is registered. In the item “component name”, the names of components belonging to the block are registered. Belonging to a block means that at least a part of the component is contained in the block. Not that there may be a block in which no component is present. In this case, a hyphen “-” indicating that no component is present is registered in the item “component name”.

For example, in the block management table 117, the following information is registered: “BL000” as the block, “(0, 0, 0)-(x1, y1, z1)” as the area, and “upper cover, lower cover, battery, keyboard” as the component names. Note that the coordinates (0, 0, 0) are the coordinates of the vertex 401a. This information indicates that the block “BL000” represents the coordinate range of the area “(0, 0, 0)-(x1, y1, z1)”, and that the components “upper cover, lower cover, battery, keyboard” belong to this block.

Next, a description will be given of the procedure of the fourth embodiment. Examples of general processing, change management, and drawing processing of the fourth embodiment are the same as those of the second embodiment illustrated in FIGS. 10 and 11, and therefore will not be further described herein. However, in place of the procedure of FIG. 11, the procedure of the third embodiment illustrated in FIG. 16 may be used. The fourth embodiment differs from the second and third embodiments in the procedure of performing drawing in step S34 of the second embodiment illustrated in FIG. 13.

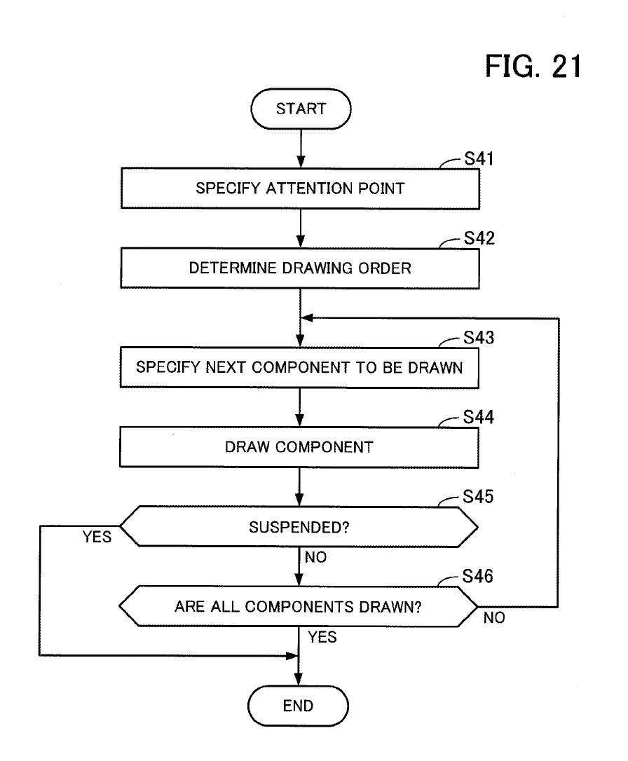

FIG. 21 is a flowchart illustrating an example of performing drawing according to the fourth embodiment. In the following, the process illustrated in FIG. 21 will be described in order of step number.

(Step S41) The drawing order determination unit 125 specifies an attention point in the current visual field, on the basis of the 3D data 111 stored in the storage unit 110a. There are, for example, the following two methods of specifying the attention point: (1) specify, as the attention point, the coordinates on a component pointed by the mouse pointer; and (2) specify, as the attention point, the coordinates on a component which a line extending from the viewpoint position along the line of sight first contacts, on the basis of the viewpoint position and the line of sight.

(Step S42) The drawing order determination unit 125 determines the drawing order in which the blocks are drawn such that a block containing the attention point is drawn with the highest priority, and blocks closer to the attention point are drawn with higher priority. Then the drawing order determination unit 125 reports the drawing order to the drawing unit 124. A determination as to which blocks are closer to the attention point may be made on the basis of the distance between the attention point and each of blocks not containing the attention point. For example, the distance between the attention point and a block not containing the attention point may be the distance between the coordinates of the attention point and reference coordinates of the block. The reference coordinates of the block may be the coordinates of the center of the block or the center of gravity of the block, for example.

(Step S43) The drawing unit 124 specifies the next block to be drawn in the determined drawing order. The drawing unit 124 specifies components contained in the block, on the basis of the block management table 117 stored in the storage unit 110a. In some cases, one component is specified. In other cases, a plurality of components are specified.

(Step S44) The drawing unit 124 draws the specified component on the basis of the 3D data of the specified component, and causes a display 12 to display the resulting image. If components contained in another block are drawn earlier and thus the component specified in step S43 is already drawn, drawing of the specified component may be skipped. If a plurality of components are specified in step S43, the drawing unit 124 draws the plurality of components.

(Step S45) The drawing unit 124 determines whether drawing is suspended. If the drawing is suspended, the process ends. If the drawing is completed without being suspended, the process proceeds to step S46. The drawing may be suspended in the case where the user performs a predetermined suspension operation using an input device 11, for example. After the drawing is suspended, the user may perform behavior verification or the like with respect to the image drawn up to that point.

(Step S46) The drawing unit 124 determines whether all the components are drawn. If all the components are drawn, the process ends. If there is a component that is not drawn, the process returns to step S43.

In this way, the drawing order determination unit 125 specifies the attention point, and determines the drawing order on the basis of the attention point.

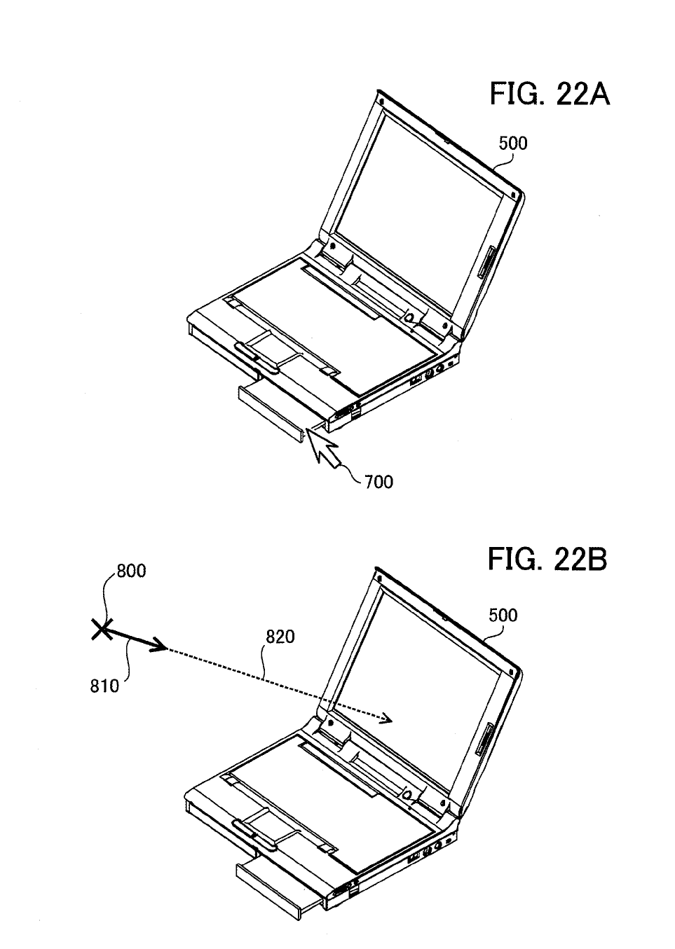

FIGS. 22A and 22B illustrate examples of methods of specifying an attention point according to the fourth embodiment. FIG. 22A illustrates a method of specifying an attention point using a mouse pointer 700. FIG. 22B illustrates a method of specifying an attention point using a viewpoint position 800 and a line of sight 810.

For example, in the case of using the mouse pointer 700, the coordinates on a component pointed by the mouse pointer 700 are specified as an attention point in the manner described above. In the example of FIG. 22A, the component pointed by the mouse pointer 700 is a CD tray. Thus, the drawing order determination unit 125 specifies the coordinates on the CD tray pointed by the mouse pointer 700 as the attention point.

Further, for example, in the case of using the viewpoint position 800 and the line of sight 810, the coordinates on a component which a line 820 (in a virtual 3D space) extending from the viewpoint position 800 along the line of sight 810 first contacts are specified as an attention point in the manner described above. In the example of FIG. 22B, the component which the line 820 first contacts is a display. Thus, the drawing order determination unit 125 specifies the coordinates on the display which the line 820 contacts as the attention point.

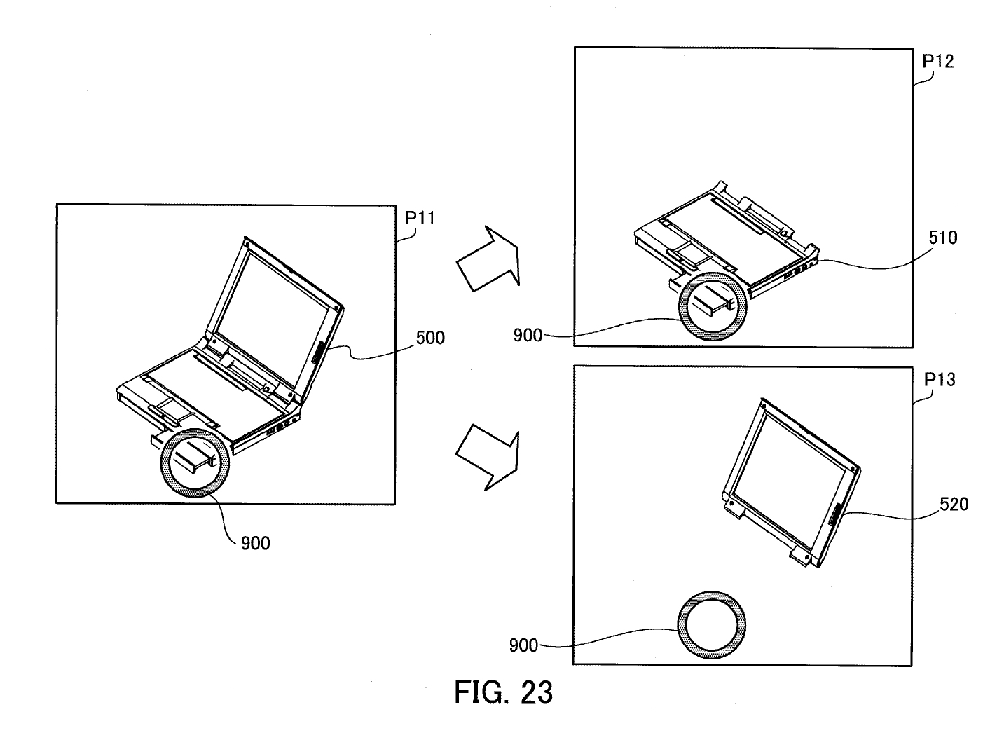

FIG. 23 illustrates a comparison between the process of the fourth embodiment and another process. In

FIG. 23, images P11, P12, and P13 are illustrated. The image P11 is an image for explaining an attention point 900. The attention point 900 is located at the coordinates on the CD tray pointed by the mouse pointer 700 illustrated in FIG. 22A.

The image P12 illustrates an assembly 510 which is displayed in the course of drawing processing in the case where the process of the fourth embodiment is employed. The image P12 also illustrates the attention point 900. The image P13 illustrates an assembly 520 which is displayed in the course of drawing processing in the case where the process of the fourth embodiment is not employed. The image P13 also illustrates the attention point 900 (in FIG. 23, a circle around the attention point 900 is denoted by the reference numeral “900”). Note that both the images P12 and P13 are in the middle stage of drawing processing. When all the components are drawn, the whole assembly 500 is drawn as in the image P11.

In the fourth embodiment, the drawing order determination unit 125 determines the drawing order such that a block containing the attention point 900 is drawn with the highest priority. Further, the drawing order determination unit 125 determines the drawing order such that blocks close to the attention point 900 are drawn with priority. Thus, the assembly 500 is drawn, starting from portions close to the attention point 900. For example, the assembly 510 is drawn in the middle stage of drawing (in the stage of the image P12). After that, the assembly 520 is drawn, starting from portions close to the attention point 900.

On the other hand, in the case where the fourth embodiment is not employed, the drawing order control by the drawing order determination unit 125 is not performed. That is, the assembly 500 is drawn, starting from a portion that is selected irrespective of the position of the attention point 900. For example, the assembly 520 might be drawn before the assembly 510, in the middle stage of drawing (in the stage of the image P13).

However, the attention point 900 is a point which the user is likely to be currently working on. If this point is drawn afterward, verification of the behavior of components drawn in the vicinity of the attention point 900 or the like (verification of the opening and closing motions of the CD tray or the like in the example of FIG. 23) may not be performed until the whole image of the assembly 500 is displayed, for example. Accordingly, the verification process might be delayed.

In view of the above, the design support apparatus 100a of the fourth embodiment determines the drawing order such that a block containing the attention point 900 is drawn with the highest priority, and blocks close to the attention point 900 are drawn with priority. Accordingly, a component which the user is likely to be currently working on may be drawn with priority. This allows the user to quickly start a verification process. For example, when the assembly 510 is drawn, the user may suspend drawing and verify the components of the assembly 510. Alternatively, after the assembly 510 is drawn, the user may verify the components of the assembly 510 while the remaining portion (the assembly 520) is being drawn.

There may be a case where it is desired to verify some components of the assembly subjected to a series of operations. In such a case, the second and third embodiments are employed such that the assembly subjected to the series of operations may be drawn at high speed. Further, the fourth embodiment is employed such that a portion to be verified may be drawn with priority (drawn before the other portions). In this way, the verification process may be performed more efficiently by combining the second and third embodiments or by combining the second and fourth embodiments.

Although the attention point is specified immediately before drawing is performed, the attention point may be specified at other timings. For example, the attention point may be specified before step S11 of FIG. 10 (before an input requesting batch reproduction is received). In this case, for example, the user may select a portion that is desired to be drawn with priority using the mouse pointer 700, and then cause the design support apparatus 100a to perform a series of operations.

As mentioned above, the information processing in the first embodiment may be realized by causing the computation unit 1b to execute the program. The information processing in the second embodiment may be realized by causing the processor 101 to execute the program. The program may be recorded in a computer-readable recording medium (for example, the optical disc 13, the memory device 14, the memory card 16, and the like).

In the case of distributing the program, a portable storage medium having the program recorded therein is provided, for example. The program may be stored in a storage unit of another computer so as to be distributed via a network. The computer may store the program recorded in the portable recording medium or the program received from the other computer in its storage unit, and may read and execute the program from the storage unit. The computer may directly execute the program read from the portable recording medium, or may directly execute the program received from the other computer via a network.

The above-described information processing may also be realized wholly or partly by electronic circuits such as DSP, ASIC, PLD, and the like.

According to an aspect, it is possible to perform drawing at high speed in response to a series of operations.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus that is used for a process of generating, on the basis of first information indicating a location of an object, second information indicating an outline of the object, and drawing the object using the second information, the information processing apparatus comprising:
a memory configured to store information on a plurality of operations that change the first information; and
a processor configured to perform a procedure including:
generating, upon sequentially performing a first operation through a second operation of the plurality of operations, second information after the second operation without generating second information for each of the first operation through an operation immediately before the second operation, and
drawing the object using the generated second information.

2. The information processing apparatus according to claim 1,
wherein the procedure further includes generating information on an amount of change in the first information made by each of the first through second operations, in place of changing the first information in response to each of the first through second operations; and
wherein the generating the second information includes generating the second information after the second operation on the basis of the information on the amount of change.

3. The information processing apparatus according to claim 2, wherein the procedure further includes, when the amount of change is not changed from before the first operation, preventing generation of the second information after the second operation by regarding the first through second operations as not being present.

4. The information processing apparatus according to claim 1, wherein the procedure further includes:
generating change information for regarding the first through second operations as a single operation; and
controlling such that the second information is generated only after the second operation out of the first through second operations, on the basis of the change information.

5. The information processing apparatus according to claim 1,
wherein the memory is configured to store information on a plurality of operations that change information on an attribute used for drawing the object other than the location of the object; and
wherein the procedure further includes, upon sequentially performing a third operation through a fourth operation of the plurality of operations, regarding each of the third through fourth operations as not being present, when the information on an attribute after the fourth operation is not changed from before the third operation.

6. The information processing apparatus according to claim 1, wherein the procedure further includes:
obtaining, upon drawing the object, information indicating a point on one of a plurality of components of the object on which attention of a user is focused;
determining a drawing order in which the plurality of components are drawn on the basis of the information indicating the point; and
drawing the plurality of components in the drawing order.

7. A drawing method that generates, on the basis of first information indicating a location of an object, second information indicating an outline of the object and draws the object using the second information, the drawing method comprising:
generating, by a processor, upon referring to information on a plurality of operations that change first information and sequentially performing a first operation through a second operation of the plurality of operations, second information after the second operation without generating second information for each of the first operation through an operation immediately before the second operation; and
drawing, by the processor, the object using the generated second information.

8. A computer-readable storage medium storing a computer program, the computer program causing a computer that generates, on the basis of first information indicating a location of an object, second information indicating an outline of the object and draws the object using the second information to perform a procedure comprising:
generating, upon referring to information on a plurality of operations that change first information and sequentially performing a first operation through a second operation of the plurality of operations, second information after the second operation without generating second information for each of the first operation through an operation immediately before the second operation; and
drawing the object using the generated second information.
